(19) United States
(12) Patent Application Publication
(10) Pub. No.: US 2010/0281611 A1
(43) Pub. Date: Nov. 11, 2010

(54) SPA DOCKING STATION AND ADJUSTABLE SEAT

(75) Inventors: Joseph Anthony Veltri, East Dundee, IL (US); Joseph Salvator Montalto, Whitewater, WI (US)

Correspondence Address: FOLEY & LARDNER LLP, 777 EAST WISCONSIN AVENUE, MILWAUKEE, WI, 53202-5306, US

(73) Assignee: European Touch Holdings,Inc.

(21) Appl. No.: 12/464,078

(22) Filed: May 11, 2009

(51) Int. Cl. A47K 3/02; F16L 37/00

(52) U.S. Cl. 4/541.1; 285/305; 4/584; 4/578.1

(57) ABSTRACT

A spa apparatus including a basin releaseably coupled to a base assembly. The basin and base assembly may be configured for quick coupling and releasing. Coupling the basin and base assembly may simultaneously couple electrical components and/or plumbing components. The basin may be interchanged for aesthetic purposes, because of wear, or for sanitation purposes. The spa apparatus may further comprise a base and a seat moveable by a support structure. The seat may be raised and lowered and/or rotated along an axis. The seat may further be moved fore and aft. A joint may releaseably secure seats having any of a number of configurations to the base assembly, with or without the use of tools, providing for quick and easy replacement of the seat.

### BACKGROUND

Spas are well known for use in facilitating comfort and relaxation. Pedicure spas specifically allow for treatment and comfort of the feet of a person in addition to other incorporated services. Accessing a pedicure spa can sometimes be complicated by the position of a seat or by other spa components. Accessing a pedicure spa can also be complicated by a person's stature, age, and physical capabilities Further, a pedicure spa may not be universally aesthetically appealing and can become stylistically outdated or worn with repeated use.

### SUMMARY

One exemplary embodiment of the invention relates to a spa apparatus, comprising a basin including an upper rim having a back edge; a support assembly having a substantially vertical axis, the support assembly including an upper portion coupleable to a first seating element, the first seating element being substantially perpendicular to the vertical axis; and a base being located below the upper rim at the back edge, the first seating element being movable by the support assembly from a first position at a first distance relative to the base to a second position at a second distance relative to the base, wherein the second distance is greater than the first distance.

Another exemplary embodiment of the invention relates to a spa apparatus, comprising a seat; a basin including a reservoir, a back portion, a front portion, and a top portion, the back portion of the basin being closer to the seat than the front portion, and the top portion of the basin including at least a first footrest supporting feature and a second footrest supporting feature; and a footrest member movable from a first position proximate the front portion of the basin to a second position intermediate the first position and the back portion of the basin, wherein the footrest member is removably secured in the first footrest receiving feature in the first position and the footrest member is removably secured in the second footrest receiving feature in the second position.

Another exemplary embodiment of the invention relates to a spa apparatus, comprising a base assembly supporting a seat; a basin coupled to the base assembly; a first electrical component and a first plumbing component coupled to the base assembly; a second electrical component and a second plumbing component coupled to the basin; a first quick release connector coupling the first electrical component and the second electrical component; and a second quick release connector coupling the first plumbing component and the second plumbing component.

### BRIEF DESCRIPTION OF THE DRAWINGS

FIG. 1 is a perspective view of a first exemplary embodiment of the spa apparatus.

FIG. 2 is an exploded view of the embodiment of FIG. 1.

FIG. 2A is a top perspective view of the joint of FIG. 2.

FIG. 3 is a perspective view of the embodiment of FIG. 1.

FIG. 4 is a perspective view of the embodiment of FIG. 1 showing the seat a lowered position.

FIG. 5 is a perspective view of the embodiment of FIG. 1 showing in-part the internal features of the basin and base and the seat raised.

FIG. 6 is a perspective view of a second embodiment of the spa apparatus.

### DETAILED DESCRIPTION

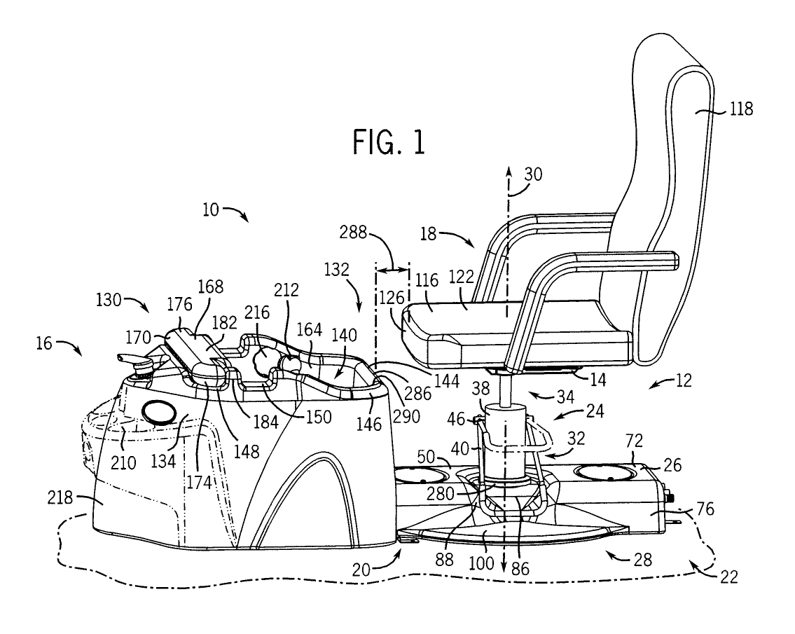

Referring to FIG. 1, a spa assembly or apparatus 10 intended to seat a person in order to facilitate services to that person is shown. In one exemplary embodiment, the person may receive a pedicure and the spa assembly 10 may be a pedicure spa. In other exemplary embodiments, the person may receive other spa services such as a manicure or a haircut.

Spa assembly 10 generally includes a base assembly 12 and a basin 16. Spa assembly 10 may further include a joint 14 and a seat 18. In one exemplary embodiment, spa assembly 10 is configured to provide a person improved access to, i.e., entry to and exit from, seat 18. In another exemplary embodiment, spa assembly 10 is configured to accommodate persons with disabilities, the elderly, and persons having a variety of statures and body types. In another exemplary embodiment, the seat and/or the basin of spa assembly 10 are configured to be quickly and easily interchanged or removed. In this manner, spa assembly 10 may be quickly customized to appeal to different aesthetic preferences and worn components may be quickly and easily replaced. In another exemplary embodiment, base assembly 12 and basin 16 of spa assembly 10 are configured to be removably coupled. In another exemplary embodiment, plumbing and electrical components are configured to be coupled with coupling mechanisms, e.g., quick release coupling mechanisms.

Base assembly 12 is configured to support seat 18 and the weight of a person in seat 18. Base assembly 12 includes a front portion 20, a back portion 22, a support assembly 24, and a base 28.

Support assembly 24 is movable along an axis. In one exemplary embodiment, support assembly 24 includes a vertical axis 30 substantially normal to the surface of the floor on which spa assembly 10 is located, support assembly being moveable therealong. Accordingly, support assembly 24 is movable upward and downward, allowing the height or vertical position of seat 18 coupled to base assembly 12 to be adjusted. Support assembly 24 is further configured to be rotatable about vertical axis 30. Accordingly, the angular orientation seat 18 may be adjusted. In another exemplary embodiment, the support assembly may be further configured to adjust the position of the seat fore and aft, i.e., toward the front portion of the base assembly and toward the back portion of the base assembly, respectively. In other exemplary embodiments, the axis may be at an angle relative to the normal to the surface of the floor on which spa assembly 10 is located. In these embodiments movement of support assembly along the axis would provide a vertical adjustment component and a horizontal adjustment component, wherein the horizontal adjustment component is an adjustment component perpendicular to the vertical component.

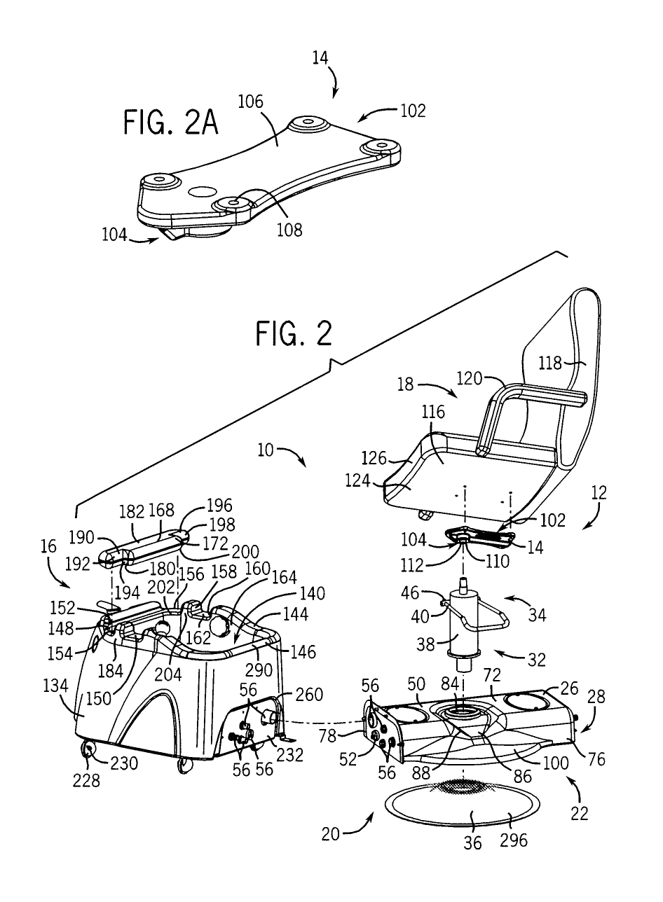

Referring to FIG. 2, support assembly 24 is shown as a pedestal support assembly including a lower portion 32, an upper portion 34. Support assembly 24 further includes a support assembly base 36, an adjustment mechanism, shown as pump 38, and an actuating mechanism, shown as pedal 40. Generally, the adjustment mechanism provides for the movement of support assembly 24. The adjustment mechanism is at least in-part operable using the actuating mechanism.

In the exemplary embodiment shown, pump 38 is a hydraulic pump configured to telescope. Pump 38 provides for upward and downward movement along vertical axis 30 and for rotational movement about vertical axis 30. While the adjustment mechanism is shown as pump 38, it may also be configured as any other mechanism sufficient to provide upward, downward, and/or rotational adjustability. For example, a pneumatic pump, electrically actuated pump, or scissor mechanisms may be used in place of the hydraulic pump. In another exemplary embodiments, the adjustment mechanism may consist of a plurality adjustment mechanisms. The adjustment mechanism may be made of metal, plastic, or any other material sufficient to provide support and adjustability to the base assembly.

Pedal 40 is pivotally operable with a person's foot. Pedal 40 is pivotally coupled to pump 38 at pivot points 46. Support assembly 24 may be raised by pressing down and then releasing pedal 40. Support assembly 24 may be lowered by holding pedal 40 down. Pedal 40 is generally operated by a spa service technician, though, it may be operated by a another party. In other exemplary embodiments, the actuating mechanism may be configured in any manner sufficient to at least in-part actuate the adjustment mechanism, including, but not limited to, a lever, a joystick, a button, and a switch.

Generally, support assembly base 36 provides stability for support assembly 24. Support assembly base 36 may also provides support for seat 18 and a person seated in seat 18. In the exemplary embodiment shown, support assembly base 36 is coupled to pump 28 and dome, though, support assembly base 36 may have any number of configurations sufficient for providing stability or support. Support assembly base 36 is shown in contact with the surface of the floor on which spa assembly 10 is located at a rim 294 having a top surface 296 and a bottom surface 298. Bottom surface 298 of rim 294 of support assembly base 36 may include a coating, e.g., rubber, to prevent unwanted movement of support assembly 24. Support assembly base 36 may further include a cavity 300 configured to receive pump 38 in part.

Spa assembly 10 may further include a connection device 26. Referring to the exemplary embodiment shown in FIGS. 1 and 2, connection device 26 is configured to facilitate coupling plumbing components and electrical components included in or coupled to spa assembly 10. Connection device 26 may be further configured to conceal plumbing components and electrical components, making spa assembly 10 more aesthetically pleasing.

Connection device 26 includes a first connection portion 52 and a second connection portion 54. Spa assembly 10 may include or be coupled to one or more plumbing components. Further, spa assembly 10 may include or be coupled to one or more electrical components. First front connection portion 52 and second connection portion 54 include a plurality of coupling points 56 at which electrical components or plumbing components may be coupled. These plumbing components and electrical components may include, but are not limited to, cold water supply lines, hot water supply lines, a power drain pump elements, gravitational emptying mechanisms, and electrical wiring.

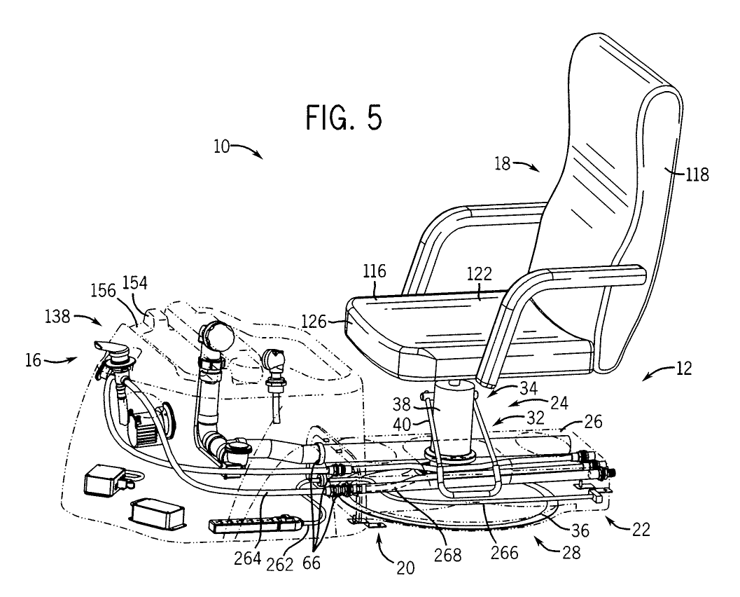

Electrical components and plumbing components may be coupled with coupling mechanisms, shown as quick release mechanisms 66 in the exemplary embodiment (see, e.g., FIG. 5). Quick release mechanisms 66 are configured to be coupled by pushing the basin toward the base, thereby removably securing the base assembly to the basin. More than one quick release mechanism may be substantially simultaneously coupled with the application of a single force. Each quick release mechanism is further configured to be released by a person using a single hand. Quick release mechanisms may include, but are not limited to, mechanisms using latches, buttons, or snapping features. In another exemplary embodiment, coupling mechanisms may be coupling mechanisms other than quick release mechanisms, for example, threaded connectors. Coupling mechanisms may be made of metal, plastic, or other suitable materials known in the art.

Further referring to FIGS. 1 and 2, connection device 26 may further include a housing or shroud 50. Housing 50 provides protection for plumbing components and electrical components and conceals these components for aesthetic purposes. Housing 50 may further help guide basin 16 and base assembly 12 together when basin 16 and base assembly 12 are releasably coupled. Housing 50 may be made of plastic or other suitable materials. Housing 50 of connection device 26 may be configured in any manner configured to facilitate coupling or concealing electrical components and/or plumbing components. In other exemplary embodiments, multiple housings are provided. In another exemplary embodiment, no housing is provided. In another exemplary embodiment, base assembly 12 does not include a connection device 26.

In the exemplary embodiment shown in FIG. 1 and FIG. 2, housing 50 includes a top side 72, a bottom side 74, a first side 76, a second side, a front side 78, and a rear or back side 82. Bottom side 74 at least in-part contacts or interfaces with the surface of the floor in the space in which spa assembly 10 is located. Bottom side 74 is configured to provide stability for connection device 26. Connection device 26 may have a coating on bottom side 74, e.g., rubber, for this purpose.

First connection portion 52 is shown at front side 78 of housing 50. Second connection portion 54 is shown at back side 82 of housing 50. A first electrical component 262 and a first plumbing component 264 are coupled to and substantially confined within housing 50 (see, e.g., FIG. 5).

In the exemplary embodiment shown connection device 26 further includes a locking element, shown as cutout 86, configured to substantially lock support assembly 24 at a given angular orientation about vertical axis 30. Cutout 86 includes a peripheral wall 88, configured to securably receive pedal 40 therein. When pedal 40 is not received in cutout 86, support assembly 24 may be rotated about vertical axis 30. When pedal 40 is received in cutout 86, support assembly 24 is substantially prevented from rotating about vertical axis 30. In alternative exemplary embodiments, other mechanical or electromechanical locking elements sufficient to lock the support assembly at a given angular orientation may be used.

Referring to FIG. 2, connection device 26 further includes an aperture 84. Aperture 84 is substantially aligned along vertical axis 30 and is configured to receive pump 38 in-part. Aperture 84 runs from top side 72 to bottom side 74, extending therethrough. Aperture 84 may be of configured in any manner sufficient to receive support assembly 24 at least in part. In other exemplary embodiments, the aperture may not be included.

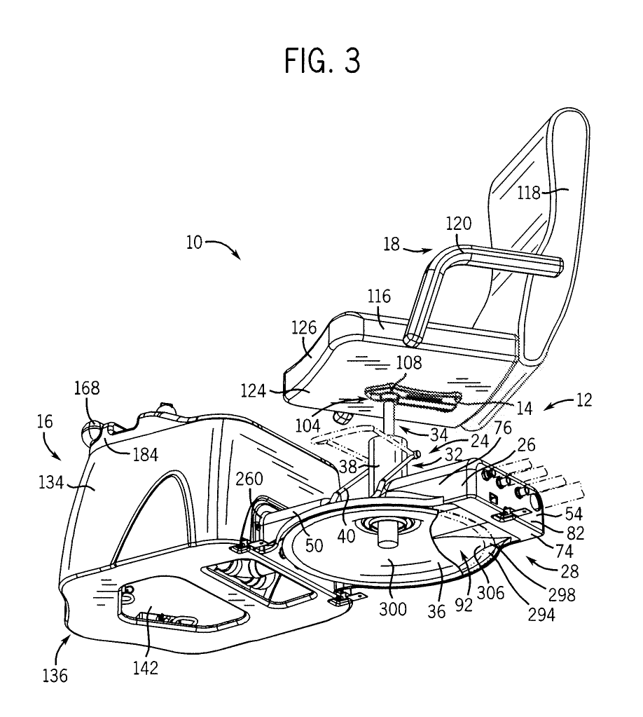

Referring to FIG. 3, aperture 84 transitions to a cavity 92 at bottom side 74 of housing 50. Cavity 92 is concave, in-part defining bottom side 74 of housing 50. An inner surface 306 of cavity 92 substantially corresponds to top surface 296 of support assembly base 36. In this manner, housing 50 substantially covers or conceals support assembly base 36 and helps position connection device 26 relative to support assembly 24. In another exemplary embodiment, a cavity may not cover the support assembly base or may cover the support assembly base only in-part.

Referring to FIGS. 1-6, base 28 is configured to provide support and stability for base assembly 12. Base may further be configured to facilitate connecting plumbing elements and electrical elements. Base may further be configured to allow for (e.g., not interfere with, enable, provide for, permit, etc.) adjustability of the seat.

Referring to the exemplary embodiment shown in FIGS. 1 and 2, base 28 has a low profile relative to basin 16. Base 28 comprises the lower portion 32 of support assembly 24 and connection device 26. Base 28 may further include securing mechanisms, shown as flanges 100, configured to secure base 28 to the surface of the floor on which spa assembly 10 is located. In one exemplary embodiment, the lower portion of the support assembly and the connection device may be at least in-part integrally formed. In another exemplary embodiment, base 28 comprises only the lower portion of the support assembly. In another exemplary embodiment, base 28 comprises the support assembly, with or without connection device 26.

Referring to FIG. 3, seat 18 includes a first seating element, shown as seat cushion 116, and a second seating element, shown as a seat back 118. In the exemplary embodiment shown, seat cushion 116 substantially perpendicular to vertical axis 30. Seat cushion 116 includes a top surface 122, a bottom surface 124, and a front surface 126. Seat back 118 may be configured to recline. The first seating element and the second seating element may further provide massage elements for the comfort of a person receiving a spa treatment, for example, vibrating elements and heating treatments. The seat may further include one or more armrests.

Joint 14 is configured to couple base assembly 12 to seat 18. Joint 14 includes a seat connection portion 102 and a base assembly connection portion 104. Joint is shown intended to be coupled to the support assembly without the use of tools. The joint is further shown intended to be removed from the support assembly without the use of tools. For example, the joint may be coupled to the support assembly and removed therefrom using a releasable latch. In another exemplary embodiment, the joint may be coupled to the support assembly using tools, e.g., a screw driver. In other exemplary embodiments, the joint may include threading, snap mechanisms, magnets, or fasteners for coupling the joint to the support assembly.

Referring to the exemplary embodiment shown in FIGS. 2-3, seat connection portion 102 includes a substantially planar top surface 106 configured to interface with seat 18 at bottom surface 124. Seat connection portion 102 is shown substantially rectangular, however, it may be configured in any manner sufficient to support seat 18. For example, seat connection portion 102 may be X-shaped, may be cross-shaped, may be a grid, or may have a sunburst configuration. Seat connection portion 102 of joint 14 may further include a coupling element, shown as holes 108, configured to facilitate securing seat connection portion 102 of joint 14 to seat 18 with fasteners, e.g., screws or bolts, or other securing mechanism. In one exemplary embodiment, fasteners are inserted in a manner in which they first extend through the seat cushion and then into the holes. After passing into the holes, a nut or other securing mechanism may be used to secure the seat cushion relative to the joint. In another exemplary embodiment, the fasteners are inserted in a manner in which they first extend through the holes of the joint and then into the seat cushion.

Base assembly connection portion 104 of joint 14 includes a cavity 110 having a cavity opening 112. Cavity opening 112 is substantially opposite substantially planar top surface 106 of seat connection portion 102. Cavity 110 is configured to receive upper portion 34 of support assembly 24. In another exemplary embodiment, the weight of seat 18 and the weight of a person receiving a spa service help keep the joint in place on the support assembly. In other exemplary embodiments, base assembly connection portion 104 may be configured in any manner sufficient to couple the seat to the support assembly.

Joint 14 may be of any configuration sufficient to couple seat 18 to base assembly 12. In one exemplary embodiment, the joint may be integral with the support assembly. In another exemplary embodiment, the joint may be integral with the seat. The joint may be made of metal, plastic or other composites of suitable strength and durability to couple the seat to the base assembly. In another exemplary embodiment, seat 18 may be coupled to base assembly 12 without joint 14.

Basin 16 is configured to accommodate and provide comfort to the feet of a person receiving a spa service. Basin is further configured to provide support for the feet of a person providing a spa service, providing additional comfort for the spa service recipient and facilitating administration of a spa service. The basin may be composed of a variety of materials, including, but not limited to plastic and composite materials. The basin may be formed by an injection molding process or by other methods known in the art.

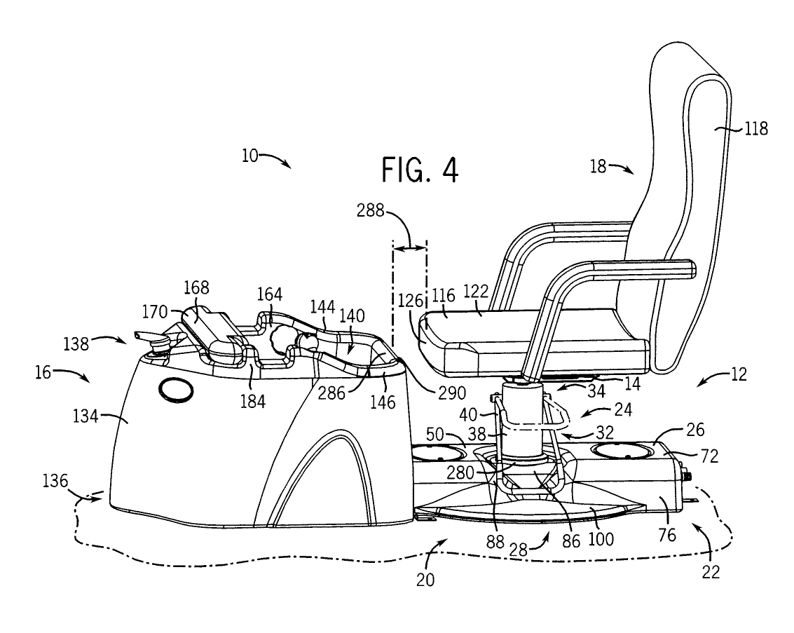

Referring to FIG. 1 and FIG. 2, basin 16 includes a front portion 130, a rear or back portion 132, an outer peripheral wall 134, a bottom portion 136, a top portion 138, and a reservoir 140 (see, e.g., FIG. 4). Outer peripheral wall 134 may include substantially vertical portions, substantially horizontal portions, curved portions, and cut-out features (see, e.g., FIG. 1). Outer peripheral wall 134 may be shaped and colored according to a person's aesthetic preferences. Bottom portion 136 of basin 16 may include apertures 142 to improve the serviceability of basin 16. Reservoir 140 of basin 16 is generally concave and configured to receive a liquid spa solution. The liquid spa solution may be water alone, water combined with soaps, oils, surfactants, salts, or other materials, or another liquid composition. Reservoir 140 is further configured to receive or accommodate the feet and/or legs of a person receiving spa services. Reservoir 140 as shown includes a peripheral wall 164 that is generally vertical.

The basin may further include massaging mechanisms that introduce air into the reservoir to provide comfort to the feet of a person receiving a spa service. For example, the basin may include aerators, nozzles, or air holes.

In the exemplary embodiment shown, top portion 138 of basin 16 includes a top surface 144 and a rim or upper rim 146. Rim 146 of top portion 138 substantially surrounds reservoir 140. Rim 146 may have a curved profile or may be otherwise shaped, e.g., for aesthetic purposes or to facilitate placement of a person's feet into the reservoir. Rim 146 includes a back edge 290. Generally, a person receiving a spa treatment extends their leg over back edge 290 into reservoir 140 when receiving a spa service.

Top portion 138 of basin 16 further includes a first footrest receiving feature, shown as first recesses 148, and a second footrest receiving feature, shown as second recesses 150, and a pair of ridges 184. First recesses 148 and second recesses 150 are configured to removably receive a footrest member 168. First recesses 148 of basin 16 each include a first wall 152, a second wall 154 and a bottom surface 156. Second recess 150 of basin 16 each include a first wall 158, a second wall 160 and a bottom surface 162. Ridges 184 are in-part defined by first recesses 148 and second recesses 150. Ridges 184 each include an inner wall 204 that generally coincides with peripheral wall 164 of reservoir 140. In other exemplary embodiments, footrest receiving features may include, but are not limited to, be a concave depressions, tabs, slots, or tracks. Such features may additionally facilitate movement of the footrest member between a first position and a second position.

Spa assembly 10 may include one or more nozzles or faucets 212. Nozzles 212 may be configured to fill reservoir 140 of basin 16 with a liquid pedicure solution. Nozzles 212 may be, for example, a pull-out spray faucet, a cold water faucet, a hot water faucet, or a constant temperature faucet. Basin 16 may also include an overflow mechanism 216. Overflow mechanism 216 prevents over-filling reservoir 140. Overflow mechanism 216 is also used to open the drain.

Basin 16 is configured to be interchangeable. Basin 16 be provided in any number of aesthetic designs. A user may replace or change a basin 16 to best suit their personal preferences or the preferences of customers. A user may also replace or change a basin due to wear and tear.

Basin 16 may be provided with casters or wheels 228 to enable basin 16 to move relative to base assembly 12. Casters or wheels 228 may further include anchors 230 to prevent undesired movement of basin 16. Casters or wheels 228 may be detachable from basin 16 or fixed thereto. Casters or wheels 228 are shown coupled to bottom portion 136 of basin 16 (see, e.g., FIG. 2 illustrating basin 16 coupled to casters or wheels 228; see also, FIG. 1 illustrating basin 16 without casters or wheels 228).

Basin 16 includes a plurality of coupling points 56, at which electrical components and/or plumbing components may be coupled. These components may include, for example, cold water supply lines, hot water supply lines, a power drain pump elements, gravitational emptying mechanisms, and electrical wires. Coupling points 56 of basin 16 may be located at a connection portion 232. In the embodiment shown, connection portion 232 is located at back portion 132 of basin 16. In the exemplary embodiment shown in FIG. 2 and FIG. 5, a second electrical component 266 and a second plumbing component 268 are coupled to basin 16. Second electrical component 266 and a second plumbing component 268 are substantially concealed within outer peripheral wall 134 of basin 16.

Referring back to FIG. 1, basin 16 may also incorporate a number of features for facilitating administration of spa services. For example, basin 16 may include spa implement receptacles, shown as pockets 210, for holding spa implements used during administration of spa services, e.g., nail clippers, files and nail polish. Basin 16 may further include one or more sloped (e.g., angled or inclined) portions provided to prevent placement of spa implements or other items on the basin in locations where these items are likely to fall or otherwise cause damage. Basin 16 may further include an undercut 218 at front portion 130 of basin 16 configured to enable a person administering a spa service to move a stool or other seating element closer to basin 16.

Footrest member 168 is configured to provide support and comfort to a spa service recipient's feet. Footrest member 168 is configured to be movable between at least a first position and a second position to more comfortably accommodate the legs, including the feet, of persons of various statures, leg lengths, etc., receiving spa services.

Referring to FIGS. 1-4, footrest member 168 includes a front side 170, a back side 172, a first side 174, a second side 176, a bottom surface 180, and a top surface 182. Footrest member 168 further includes a first notch or groove 190 defining a first wall 192 and a second wall 194 and a second notch or groove 196 defining a first wall 198 and a second wall 200.

Referring to FIGS. 1-5, footrest member 168 is shown movable between a first position proximate front portion 130 of basin 16 and a second position intermediate the first position and back portion 132 of basin 16. In the second position, footrest member 168 is closer to back edge 290 of basin 16 than in the first position. In the exemplary embodiment shown, footrest member 168 may be moved manually, e.g., picked up by hand and moved into second recesses 150 from first recesses 148, and, similarly, picked up by hand and moved from first recesses 148 into second recesses 150. In other exemplary embodiments, footrest member 168 may be moved from the first position to the second position using a variety of methods or devices, including, but not limited to, a slidable device or a rotatable device.

The distance between the ends of first side 174 and second side 176 of footrest member 168 is substantially greater than the distance between inner edges 202 of first recesses 148 and substantially greater than the distance between inner edges 202 of second recesses 150. The distance between second wall 194 of first notch or groove 190 and the second wall 200 of second notch or groove 196 is substantially lesser than the distance between inner edges 202 of first recesses 148 and substantially lesser than the distance between inner walls 204 of second recesses 150.

In the first position, front side 170 of footrest member 168 is substantially integral with rim 146 of top portion 138 of basin 16. In this manner, footrest member 168 does not substantially obstruct reservoir 140, e.g., while a person receiving a spa service is soaking their feet. Footrest member 168 is removably secured in first recesses 148. Fore and aft motion of footrest member 168 is prevented by confining footrest member 168 within first recesses 148 between first wall 152 of and second wall 154. Footrest member 168 is supported by the bottom surface 156 of first recesses 148. First notch or groove 190 and second notch or groove 196 receive ridges 184. First wall 192 of the first notch or groove 190 and first wall 198 of second notch or groove 196 substantially interface with second walls 154 of first recesses 148. Second wall 194 of first notch or groove 190 and second wall 200 of second notch or groove 196 substantially interface with inner walls 204 of ridges 184, substantially preventing side-to-side movement of footrest member 168.

In the second position, footrest member 168 extends across reservoir 140 and is located closer to back edge 290 of rim 146 than it is in the first position. Footrest member 168 is removably secured in second recesses 150. Fore and aft motion of footrest member 168 is prevented by confining footrest member 168 within second recesses 150 between first wall 158 and second wall 160. Footrest member 168 is supported by bottom surfaces 162 of second recesses 150. First notch or groove 190 and second notch or groove 196 receive a portion of rim 146. First wall 192 of the first notch or groove 190 and first wall 198 of second notch or groove 196 substantially interface with second walls 160 of second recesses 150. Second wall 194 of first notch or groove 190 and second wall 200 of second notch or groove 196 substantially interface with a portion of peripheral wall 164 of reservoir 140, substantially preventing side-to-side movement of footrest member 168.

In other exemplary embodiments, footrest member 168 may be removably received in any features sufficient to substantially confine the footrest member, e.g., prevent side-to-side movement and fore and aft movement. In one alternative exemplary embodiment, footrest member 168 may hook over the edges of basin 16 to secure it in place. In another alternative exemplary embodiment, footrest member 168 may also be secured using a snapping or latch mechanism.

Basin 16 is configured to be removably coupled to base assembly 12. Referring to FIG. 2, connection portion 232 on back portion 132 of basin 16 is coupled to first connection portion 52 of connection device 26 at coupling points 56 via coupling mechanisms. First electrical component 262 is coupled to second electrical component 266 and first plumbing component 264 is coupled to second plumbing component 268. In one exemplary embodiment, the coupling mechanisms are quick released mechanisms 66 configured to couple basin 16 and base assembly 12 with one push of basin 16 toward base assembly 12. Multiple quick release mechanisms may be simultaneously coupled. For example, a single application of force may simultaneously couple first electrical component 262 and second electrical component 266 and first plumbing component 264 and second plumbing component 268. Coupling mechanisms 66 may be uncoupled to allow basin 16 to be removed from base assembly 12. Components coupled with quick release mechanisms may be uncoupled by a person using a single hand. In another exemplary embodiment, connections portions may couple only plumbing components or only electrical components.

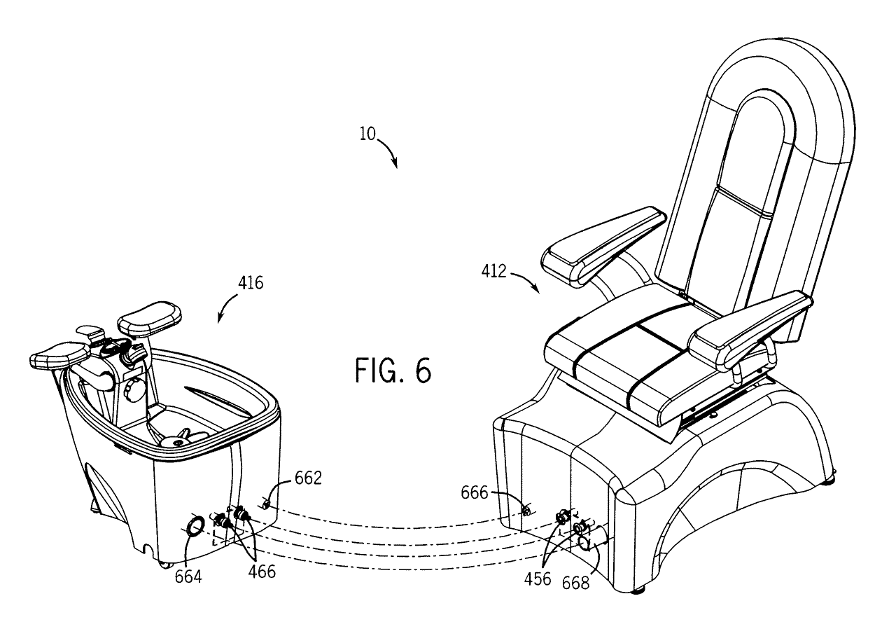

Referring to FIG. 6, spa assembly 10 is shown according to a second exemplary embodiment including a base assembly 412 configured to be removably coupled to basin 416. A first electrical component 662 and a first plumbing component 664 are coupled to basin 416 and a second electrical component 666 and a second plumbing component 668 are coupled to base assembly 412. Coupling points 456 on first coupling portion on base assembly 412 are coupled to coupling points 456 on coupling portion 632 of basin 416 via coupling mechanisms, shown as quick release mechanisms 466. Quick release mechanisms 466 may be simultaneously coupled. A single application of force, for example, pushing basin 416 toward base assembly 412, may couple first electrical component 662 and second electrical component 666 and first plumbing component 664 and second plumbing component 668. Coupling mechanisms 466 may be uncoupled to allow basin 416 to be removed from base assembly 412. Components coupled with quick release mechanisms may be uncoupled by a person using a single hand.

Referring back to the exemplary embodiment shown in FIG. 2 and FIG. 3, the assembly of the spa assembly according to the first exemplary embodiment will now be discussed. Connection portion 232 is depressed or sunken into peripheral wall 164 of basin 16 and first connection portion 52 of connection device 26 is insertable therein. Thus, first connection portion 52 is coupled to connection portion 232 substantially beneath basin 16. This configuration helps to maintain the stability and alignment of connections made at the interface of first connection portion 52 and connection portion 232. A seal 260 may substantially surround connection portion 232 on back portion 132 of basin 16 to provide a substantially seamless and stable connection between basin 16 and connection device 26.

Further referring to FIG. 2 and FIG. 3, support assembly 24 is coupled to connection device 26. Pump 38 is received in aperture 84 of connection device 26 and housing 50 of connection device 26 in-part surrounds pump 38. Pump 38 is coupled to support assembly base 36, e.g., threadably coupled. Housing 50 of connection device 26 substantially covers support assembly base 36 to form base 28. Inner surface 306 of cavity 92 substantially corresponding to and aligned with top surface 296 of support assembly base 36. Base assembly 12 may further include a collar 280 surrounding pump 38 where pump 38 enters aperture 84 on top side 72 of housing 50 of connection device 26. Collar may be configured to prevent the introduction of unwanted fluids and other matter or debris into the aperture and also may cover fastening mechanisms for aesthetic purposes.

Referring to FIG. 2, FIG. 2A, and FIG. 3, joint 14 is coupled to seat 18. Seat connection portion 102 interfaces with bottom surface 124 of seat 18. Planar top surface 106 may be configured to substantially correspond with bottom surface 124 of the seat. Fasteners may be received in holes 108 of seat connection portion 102.

Joint 14 is configured to be coupled or secured to any number of seats, for example, office-style seats. Thus, a seat may be quickly easily interchanged in accordance with aesthetic preferences and/or because of wear and tear.

Upper portion 34 of support assembly 24 is secured within cavity 110 of joint 14. In the exemplary embodiment shown, joint 14 is secured without the use of tools. Similarly, joint 14 is configured to be removed from support assembly 24 without the use of tools.

Spa assembly 10 may be coupled to the plumbing components and electrical components of a building or space in which the spa assembly resides via coupling points 56 of second connection portion 54 of base assembly 12.

Referring to FIGS. 1 and 4, seat 18 is moveable by the support assembly from a first position to a second position. At the first position, seat 18 is at a first distance relative to base 28. At the second position, seat 18 is at a second distance relative to base 28, the second distance being greater than the first distance. Base 28 is shown located below a top surface or edge 286 of rim 146 of at back edge 290 of basin 16. Base 28 does not interfere with the movement of seat 18

Referring to FIG. 1, in the first position seat cushion 116 of seat 18 is located above a top surface 286 of rim 146 at back edge 290, e.g., bottom surface 124 of seat cushion 116 is above the top surface 286 of rim 146 at back edge 290. Referring to FIG. 4, seat cushion 116 of seat 18 is shown substantially below the top surface 286 of rim 146 at back edge, e.g., bottom surface 124 of seat cushion 116 is at or below the top surface 286 of rim 146 at back edge 290. In the second position, seat cushion 116 may be at or below the top surface 286 of rim 146 at back edge. Accordingly, spa assembly 10 is configured to enable a seat 18 to be movable from a first position substantially above rim 146 of basin 16 to a second position substantially below rim 146.

In another exemplary embodiment, the bottom surface of the seat cushion may be above the rim in both the first position and the second position. In another exemplary embodiment, the bottom surface of the cushion may be below the upper rim in both the first position and the second position.

Pedal 40 of support assembly 24 enables a user to move seat 18 between the second position and the first position. Pumping pedal 40 causes pump 38 to extend or telescope upwards along vertical axis 30, raising seat 18 from the first position to the second position. Seat 18 is maintained in the second position by pushing pedal 40 to an inactive or downward orientation. Referring to FIG. 1, pedal 40 in a downward orientation is received in cutout 86. Support assembly 24 is moved from the second position to the first position by pressing and holding pedal 40 downward. While the pedal 40 is shown to correspond with cutout 86 of first side 76 of housing 50, it should be noted that the pedal may be at any orientation about support assembly 24. For example, the pedal may be oriented toward the rear of the support assembly, substantially opposite the basin. The pedal may also be oriented to one side of the support assembly opposite another side where a spa service recipient accesses the seat.

Seat 18 is rotatable by support assembly 24 about vertical axis 30 between a first in-use position and a second entry-exit position. Referring to FIG. 1, seat 18 is shown in an exemplary first in-use position. In the first in-use position, front surface 126 of seat cushion 116 is generally facing or proximate to front portion 130 of basin 16. In this position, a person sitting in seat 18 may comfortably extend their legs over the back edge 290 of rim 146 in order receive a pedicure or other spa services.

Referring to FIG. 3, seat 18 is shown in an exemplary second entry-exit position wherein a person receiving spa service may be provided improved access, i.e., entry and exit, to seat 18. In the second entry-exit position, front surface 126 of seat cushion 116 is rotated away from front portion 130 of basin. Generally, the front surface is rotated to one side or another side of the base assembly to facilitate entry to and exit from the spa assembly for a spa service recipient. For example, in the second entry-exit position the front surface of the seat cushion may be rotated to an orientation ninety degrees from the orientation in the first in-use position. In this manner, a person may enter and exit seat 18 substantially without having to maneuver their body around or over an arm rest, the sides of the seat, or other spa components. In one exemplary embodiment, the support assembly is rotatable manually. In other exemplary embodiments, the support assembly may be rotated using any of a number of mechanical or electromechanical devices. In another exemplary embodiment, the base assembly may be further provided with stops to limit the range of angular orientations to which support assembly and the seat may be rotated.

Before a person enters the seat, the seat may be adjusted to a height allowing them to comfortably enter the seat. A person enters the seat in the second entry-exit position. The seat is adjustable to a desired height using the actuating mechanism and is rotatable towards the first in-use position, enabling the person to comfortably position their feet and/or legs within the reservoir of the basin. A person may exit the seat in a similar manner. A person may remove their feet and/or legs from the reservoir of the basin. The seat may then be rotated from the first in-use position to the second entry-exit position and then lowered. It should be noted that in some instances it may be desirable to change the order of the entry and exit steps discussed above.

Referring to FIG. 1 and FIG. 4, there is a clearance 288 between seat 18 and basin 16 throughout the movement of seat 18 between the first in-use position and the second entry-exit position. Clearance 288 facilitates adjustment and movement of seat 18. Clearance 288 prevents friction and rubbing between basin 16 and seat 18. Friction and rubbing may cause wear to the basin and the seat. Friction may also impede upward movement, downward movement, and/or rotation of seat 18.

The ability to raise and lower the support assembly and to rotate the support assembly about an axis provides improved access to spa assembly 10 for persons receiving spa services. Both the height and the angular orientation of the seat can be customized to the person accessing the chair, making the persons entry and exit to the spa assembly more comfortable. This is particularly useful to accommodate those of various statures, ages, and physical capabilities.

Footrest member 168 may be located in the first position at a number of times during the administration of a spa service, e.g., while the feet of a person receiving a spa service are soaking in reservoir 140 filled with a liquid spa solution. Footrest member 168 may remain in first position or may be moved the second position at other times during administration of a spa service, e.g., when the person's feet are not soaking. Whether or not the footrest member is moved is dependent on whether it is more comfortable for the spa service recipient to have the footrest member in the first position or the second position when resting their feet thereon, e.g., having their feet supported by the footrest member. Accordingly, spa assembly 10 is configured to provide a comfortable spa experience for people receiving spa services.

For purposes of this disclosure, the term “coupled” means the joining of two components (electrical or mechanical) directly or indirectly to one another. Such joining may be stationary in nature or movable in nature. Such joining may be achieved with the two components (electrical or mechanical) and any additional intermediate members being integrally defined as a single unitary body with one another, with the two components or the two components and any additional member being attached to one another. Such joining may be permanent in nature or alternatively may be removable or releasable in nature.

Although specific shapes of each element have been set forth in the drawings, each element may be of any other shape that facilitates the function to be performed by that element.

The present disclosure has been described with reference to exemplary embodiments, however, workers skilled in the art will recognize that changes may be made in form and detail without departing from the spirit and scope of the invention. For example, although different exemplary embodiments may have been described as including one or more features providing one or more benefits, it is contemplated that the described features may be interchanged with one another, or, alternatively, be combined with one another in the described exemplary embodiments or in other alternative embodiments. Because the technology of the present disclosure is relatively complex, not all changes in the technology are foreseeable. The present disclosure described with reference to the exemplary is manifestly intended to be as broad as possible. For example, unless specifically otherwise noted a single particular element may also encompass a plurality of such particular elements.

It is also important to note that the construction and arrangement of the elements of the assembly as shown in the exemplary embodiments is illustrative only. Although only a certain number of embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the assemblies may be reversed or otherwise varied, the length or width of the structures and/or members or connectors or other elements of the system may be varied, the nature or number of adjustment or attachment positions provided between the elements may be varied. It should be noted that the elements and/or assemblies of the system may be constructed from any of a wide variety of materials that provide sufficient strength or durability. Accordingly, all such modifications are intended to be included within the scope of the present disclosure. Other substitutions, modifications, changes and omissions may be made in the design, operating conditions and arrangement of the exemplary and other exemplary embodiments without departing from the spirit of the present subject matter.

1. A spa apparatus, comprising:
a basin including an upper rim having a back edge;
a support assembly having a substantially vertical axis, the support assembly including an upper portion coupleable to a first seating element, the first seating element being substantially perpendicular to the vertical axis; and
a base being located below a top surface of the upper rim at the back edge, the first seating element being movable by the support assembly from a first position at a first distance relative to the base to a second position at a second distance relative to the base, wherein the second distance is greater than the first distance.

2. The spa apparatus of claim 1, wherein in the first position the first seating element is located above the upper rim at the back edge and in the second position the first seating element is located at or below the upper rim at the back edge.

3. The spa apparatus of claim 1, wherein the support assembly includes a fore and aft adjustment mechanism.

4. The spa apparatus of claim 1, wherein the support assembly is a pedestal support assembly.

5. The spa apparatus of claim 4, wherein the pedestal support assembly includes a telescoping hydraulic pump.

6. The spa apparatus of claim 1, wherein the seat is rotatable about the vertical axis by the support assembly from a first in-use position to a second entry-exit position.

7. The spa apparatus of claim 6, wherein there is a clearance between the basin and the first seating portion throughout movement of the seat between the first in-use position and the second entry-exit position.

8. The spa apparatus of claim 6, wherein the base further includes a locking feature to substantially lock the support assembly at a given angular orientation about the vertical axis.

9. The spa apparatus of claim 1, further including a joint coupling the first seating element to the upper portion of the support assembly.

10. The spa apparatus of claim 9, wherein the joint is couplable to the upper portion of the support assembly without tools.

11. The spa apparatus of claim 1, further including a connection device having a housing and a first connection portion, wherein the first connection portion interfaces with the basin to couple at least a first plumbing component coupled to the connection device to a second plumbing component coupled to the basin.

12. The spa apparatus of claim 11, further comprising a quick release connector coupling first plumping component and the second plumbing component.

13. The spa apparatus of claim 1, further including a footrest member movable between at least a first position to a second position, the footrest member being closer to the back edge of the basin in the second position than in the first position.

14. The spa apparatus of claim 13, wherein the basin further includes a first pair of recesses and a second pair of recess, footrest member being confined by the first pair of recesses in the first position and confined by the second pair of recesses in the second position.

15. A spa apparatus, comprising:
a seat;
a basin including a reservoir, a back portion, a front portion, and a top portion, the back portion of the basin being closer to the seat than the front portion, and the top portion of the basin including at least a first footrest supporting feature and a second footrest supporting feature; and
a footrest member movable from a first position proximate the front portion of the basin to a second position intermediate the first position and the back portion of the basin, wherein the footrest member is removably secured in the first footrest receiving feature in the first position and the footrest member is removably secured in the second footrest receiving feature in the second position.

16. The spa apparatus of claim 15, wherein the top portion of the basin further includes an upper rim surrounding the reservoir, the footrest member being substantially integral with the upper rim in the first position.

17. The spa apparatus of claim 15, wherein the footrest member extends substantially across the reservoir in the second position.

18. The spa apparatus of claim 15, wherein the first footrest receiving feature is a pair of recesses and the second footrest receiving feature is a pair of recesses.

19. The spa apparatus of claim 15, wherein at least one of the first footrest supporting feature and the second footrest supporting feature prevents fore and aft movement and side-to-side movement of the footrest member when positioned therein.

20. A spa apparatus, comprising:
a base assembly supporting a seat;
a basin coupled to the base assembly;
a first electrical component and a first plumbing component coupled to the base assembly;
a second electrical component and a second plumbing component coupled to the basin;
a first quick release connector coupling the first electrical component and the second electrical component; and
a second quick release connector coupling the first plumbing component and the second plumbing component.

21. The spa apparatus of claim 20, wherein each quick release connector is configured to be coupled by pushing the basin toward the base, thereby removably securing the base assembly to the basin.

22. The spa apparatus of claim 20, wherein the first electrical component and the second electrical component and the first plumbing component and the second plumbing component are substantially simultaneously coupleable with the application of a single force.

23. The spa apparatus of claim 20, wherein the first and second quick release connector are releasable by a user using a single hand.
